(19) United States
(12) Patent Application Publication
(10) Pub. No.: US 2023/0178256 A1
(43) Pub. Date: Jun. 8, 2023

(54) Magnetic Energy Force to Create A Nuclear Fusion Reaction

(71) Applicant: Aqeel Jabir Hasan, Villa Rica, GA (US)

(72) Inventor: Aqeel Jabir Hasan, Villa Rica, GA (US)

(21) Appl. No.: 17/951,143

(22) Filed: Sep. 23, 2022

(51) Int. Cl. G21B 1/05

(52) U.S. Cl. CPC G21B 1/05

(57) ABSTRACT

The methods, apparatuses, devices, and system described are utilized to create a nuclear fusion or fission reaction. The process uses the rejection force of magnetic energy in a super cooled environment that freezes the neutrons in place. This allows molecules to be added directly into the magnetic field and either be captured in the energy field or changed and passing through the field. The process also is designed to have a mechanical force applied to increase the magnetic rejection force, which will directly increase the energy of the rejection force.

This process will separate molecules and/or fuse molecules together depending on the rejection energy and applied force. There is also an option to add centrifugal force. Super cooled magnetic rejection energy with an applied mechanical and centrifugal force will create a nuclear reaction.

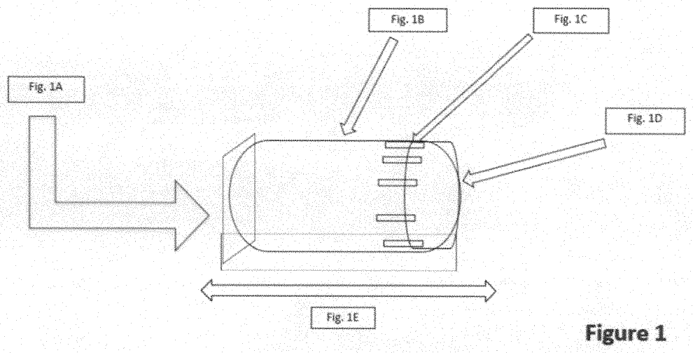

### FIG. 1

FIG. 1A: Platform that holds the container and magnet. The platform is powered by a motor and affixed to a rail system so that it can move back and forth. The platform would move the system closer to its adjacent system to create a magnetic force field. the closer the systems move together the stronger the magnetic field will be. Each system can be identical or have a bigger or smaller magnet depending on how much energy is needed for the specified process.

FIG. 1B: The container is for the super coolant. It is insulated on the bottom and the sides. The front side does not have any insulation so that the magnet can be in direct contact with the temperature of the coolant.

FIG. 1C: Braces to hold the magnet in place close to the container. Or can use a designed holding plate to do the same thing.

FIG. 1D: Magnet

FIG. 1E: Platform can move forward and backward.

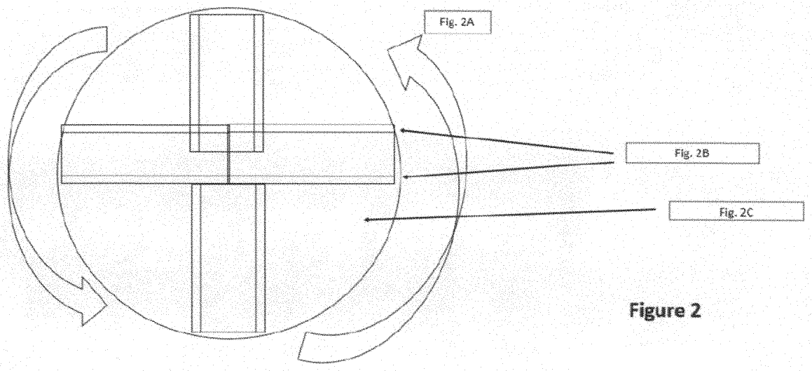

### FIG. 2

FIG. 2A: This is the bottom plate that FIG. #1 will be affixed to. The white lines indicate the railing system that will allow figure one to move forward and backwards. The plate can also spin clockwise or counterclockwise to create more energy.

FIG. 2B: Railing Apparatus

FIG. 2C: This is the bottom plate.

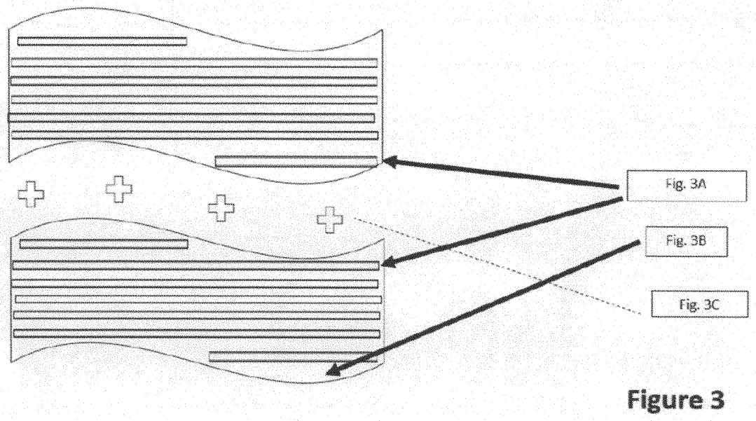

### FIG. 3

Description Function: These are Magnetic Cold Panels. By placing one MCP on top of an object and the other on the bottom a magnetic field is created. With big enough magnets and placed properly around an object, it will protect the object from being crushed by atmospheric pressure

FIG. 3A: Magnet Strips

FIG. 3B: Coolant Panels: Super Coolant flows throughout

FIG. 3C: Magnetic Field created by facing like-sides toward each other.

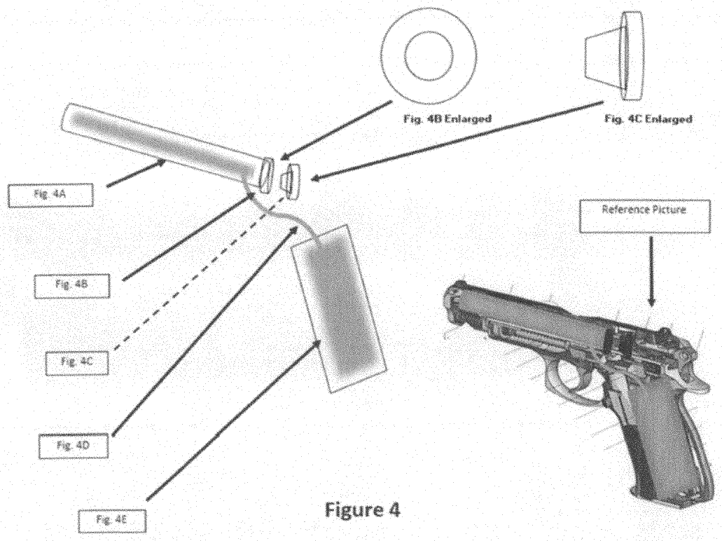

### FIG. 4

Description Function: When a cold cartridge is connected to the quick-connect, the super coolant flows into the barrel creating a cold chamber. The magnet connected to the barrel is being chilled and locking the magnetic field in place between itself and the other magnet attached to the firing pen. When the trigger is pulled, the cone magnet will slam into the magnet with the whole and cause the magnetic field to shatter and force the energy through the cold barrel and release an energy burst. Size of magnets, force of firing pen, temperature of coolant are variables that will determine the amount of force/energy released by pulling the trigger.

FIG. 4A: This is a cold barrel. A super coolant can be pumped into it from the clip. The barrel will hold the liquid and create a cold chamber in the center of the barrel.

FIG. 4B: This a magnet that would be modified to be a part of the firing pen/hammer. The magnet has a cone-type shape that is designed to fit directly into the magnet with the doughnut whole. See FIG. 4B Enlarged.

FIG. 4C: This is a magnet. It is shaped like a doughnut with a whole in the middle. The magnet is placed at the opening of the cold barrel. The whole must be affixed to the opening of the barrel. See FIG. 4C Enlarged.

FIG. 4D: This the quick-connect valve that will allow the coolant to flow from the cartridge to the barrel.

FIG. 4E: This the cold cartridge. The cartridge would be compact and made of a material that could shield its temperature from freezing the hand grip. On the top end of the cartridge is a quick-connect connector to allow for quick reloading. The cartridge would be pressurized so that once it is connected the liquid easily flows to the barrel.

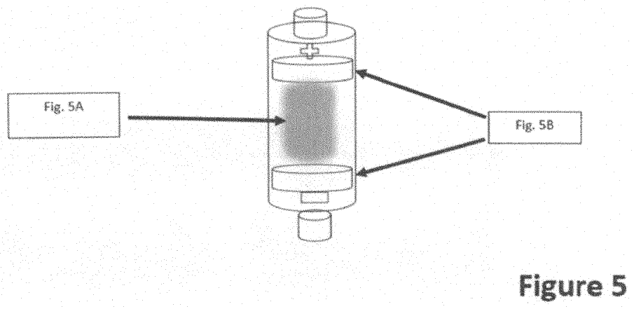

### FIG. 5

Description Function: Place the battery into a battery-operated product with the positive end to the positive and negative to negative. The super coolant has created a magnetic field that will super charge the item it is being used on. The energy will be sustained for as long the coolant lasts.

FIG. 5A: Super Coolant

FIG. 5B: Magnets

1. I, Aqeel Jabir Hasan, claim that I have designed a functional process for creating a nuclear fusion reactor by using my magnetic force/energy design. The design will force molecules together. It will also create enough energy to blow particles apart and utilized clean energy as a nuclear fission reactor.
